(19) United States
(12) Patent Application Publication
(10) Pub. No.: US 2022/0312126 A1
(43) Pub. Date: Sep. 29, 2022

(54) Detecting Hair Interference for a Hearing Device

(71) Applicant: SONOVA AG, Staefa (CH)

(72) Inventor: Gregory Rosenthal, Männedorf (CH)

(73) Assignee: SONOVA AG

(21) Appl. No.: 17/210,270

(22) Filed: Mar. 23, 2021

(51) Int. Cl. H04R 25/00

(52) U.S. Cl. CPC H04R 25/30; H04R 2225/021; H04R 2225/41

(57) ABSTRACT

An exemplary hearing device includes a microphone configured to capture an audio signal and a processor communicatively coupled to the microphone. The processor may be configured to determine that the audio signal includes hair interference noise caused by hair movement associated with a user of the hearing device, and adjust, based on the determining that the audio signal includes the hair interference noise, an operation of the hearing device.

### BACKGROUND

A user's hair can negatively impact performance of a hearing device worn by the user. For example, the user's hair may scrape over the hearing device and cause the hearing device to produce irritating sounds that can result in an uncomfortable user experience. The hair may also collect moisture and cause a high level of humidity in the operating environment of the hearing device, which can cause damage to the hearing device.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary hearing device.

FIG. 2 illustrates exemplary operations that may be performed by the hearing device of FIG. 1.

FIG. 3 illustrates an exemplary flowchart showing operations that may be performed by the hearing device of FIG. 1.

FIGS. 4-6 illustrate exemplary training stages of different machine learning models.

FIG. 7 illustrates an exemplary user interface.

FIG. 8 illustrates an exemplary computing device.

### DETAILED DESCRIPTION

Hearing devices, systems, and methods for detecting hair interference with operations of the hearing devices are described herein. As will be described in more detail below, an exemplary hearing device may comprise a microphone configured to capture an audio signal and a processor communicatively coupled to the microphone. The processor may be configured to determine that the audio signal includes hair interference noise caused by hair movement associated with a user of the hearing device, and adjust, based on the determining that the audio signal includes the hair interference noise, an operation of the hearing device. Hair movement can refer to a single strand or multiple strands of hair moving, touching, rubbing, or moving against or on a component of a hearing device such that it creates a sound wave. Although hair movement may create audible sound, it may also create inaudible sound for a hearing device user that is recorded, amplified, and provided to the user in an audible form. In some implementations, the hair movement results in hair interference noise that may create an unpleasant sound for the hearing device user unless it is removed, de-noised, or filtered out by the hearing device in the output signal. The unpleasant hair interference noise can relate to a fuzzy sound, impulse sound associated with hair hitting a hearing device, “scratchy” sound, or otherwise undesired sound by the hearing device user related to hair movement. The hair movement generally refers to hair (single strand or multiple) coming into physical contact with a component of hearing device, including the housing and/or microphone of the hearing device.

Hearing devices, systems, and methods described herein are advantageous in a number of technical respects. As described herein, a hearing device of a user may detect hair interference noise caused by user hair in an audio signal captured by a microphone of the hearing device and may adjust operations of the hearing device accordingly. For example, the hearing device may at least partially remove the hair interference noise from the audio signal and/or adjust operation parameters of the hearing device to minimize impact of the hair interference noise on an output signal provided to the user. As a result, a user experience of the user with the hearing device can be improved. The hearing device may also present a notification (e.g., on a computing device of the user) to inform the user about the hair interference with operations of the hearing device so that the user can adjust the user hair to address such hair interference.

Moreover, as described herein, the hearing device may generate a hair interference record including data about the hair interference, and transmit the hair interference record to a computing device, such as a server, associated with a clinical facility of the user. The clinical facility may use the hair interference record in analyzing hair interference for various types of hearing devices. As a result, the clinical facility may provide an effective recommendation for a hearing device and/or for a customized option of a hearing device to a person who is subjected to hearing impairment. Other advantages and benefits of the hearing devices, systems, and methods described herein will be made apparent herein.

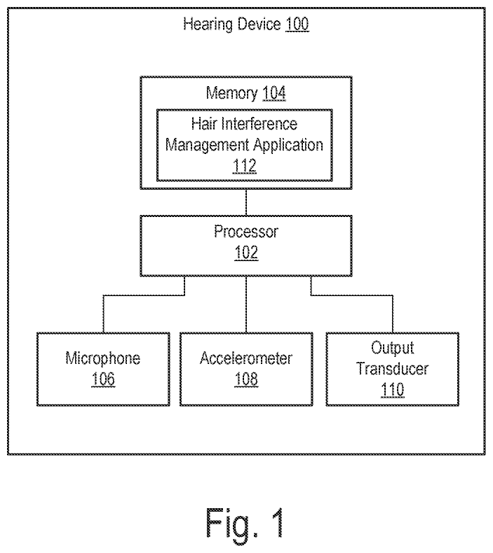

FIG. 1 illustrates an exemplary hearing device 100 that can detect hair interference with operation of hearing device 100. Hearing device 100 may be implemented by any type of device configured to provide or enhance hearing capability for a user. For example, hearing device 100 may be implemented by a hearing aid configured to provide an audible signal (e.g., amplified audio content) to a user, a sound processor included in a cochlear implant system configured to apply electrical stimulation representative of audio content to a user, a sound processor included in a system configured to apply both acoustic and electrical stimulation to a user, or any other suitable hearing prosthesis.

In some examples, hearing device 100 may be implemented by a behind-the-ear (“BTE”) component configured to be worn behind an ear of a user. Additionally or alternatively, hearing device 100 may be implemented by an in-the-ear (“ITE”) component configured to be at least partially inserted within an ear canal of a user. Additionally or alternatively, hearing device 100 may be implemented by a completely-in-canal (“CIC”) component configured to be completely inserted within an ear canal of a user. In some examples, hearing device 100 may include a combination of an ITE component, a BTE component, a CIC component, and/or any other suitable component.

As depicted in FIG. 1, hearing device 100 may include a processor 102 communicatively coupled to a memory 104, a microphone 106, an accelerometer 108, and an output transducer 110. Hearing device 100 may include additional or alternative components as may serve a particular implementation.

Microphone 106 may be implemented by any suitable audio detection device and is configured to detect audio content ambient to a user of hearing device 100. Microphone 106 may be included in or communicatively coupled to hearing device 100 in any suitable manner.

Accelerometer 108 may be implemented by any suitable sensor configured to detect movement (e.g., acceleration) of hearing device 100. While hearing device 100 is being worn by a user, the detected movement of hearing device 100 is representative of movement by the user. In some alternative examples, hearing device 100 may not include accelerometer 108.

Output transducer 110 may be implemented by any suitable audio output device, such as a loudspeaker of a hearing device or an output electrode of a cochlear implant system.

Memory 104 may be implemented by any suitable type of storage medium and may be configured to maintain (e.g., store) executable data used by processor 102 to perform any operation associated with hearing device 100 described herein. For example, memory 104 may store instructions such as a hair interference management application 112 that may be executed by processor 102 to perform any operation associated with detecting hair interference described herein. The instructions may be implemented by any suitable application, software, code, and/or other executable data instance.

Memory 104 may also maintain any data received, generated, managed, used, and/or transmitted by processor 102. For example, memory 104 may maintain data representative of an audio signal captured by microphone 106, hair interference noise detected in the audio signal, hair interference records, etc. In addition, memory 104 may maintain any data suitable to facilitate communications (e.g., wired and/or wireless communications) between hearing device 100 and other devices, such as a user device (e.g., a mobile phone, a tablet, a laptop, etc.) of the user, a computing device (e.g., a server) associated with a clinical facility, etc. Memory 104 may maintain additional or alternative data in other implementations.

Processor 102 may be configured to perform various processing operations with respect to detecting hair interference. For example, processor 102 may execute hair interference management application 112 stored in memory 104 to detect hair interference noise in an audio signal, adjust various operations of hearing device 100 to reduce negative impacts of the hair interference noise, etc. Example implementations and operations that may be performed by processor 102 are described in more detail herein. In the present disclosure, any references to operations performed by hearing device 100 or hair interference management application 112 may be understood to be performed by processor 102 of hearing device 100.

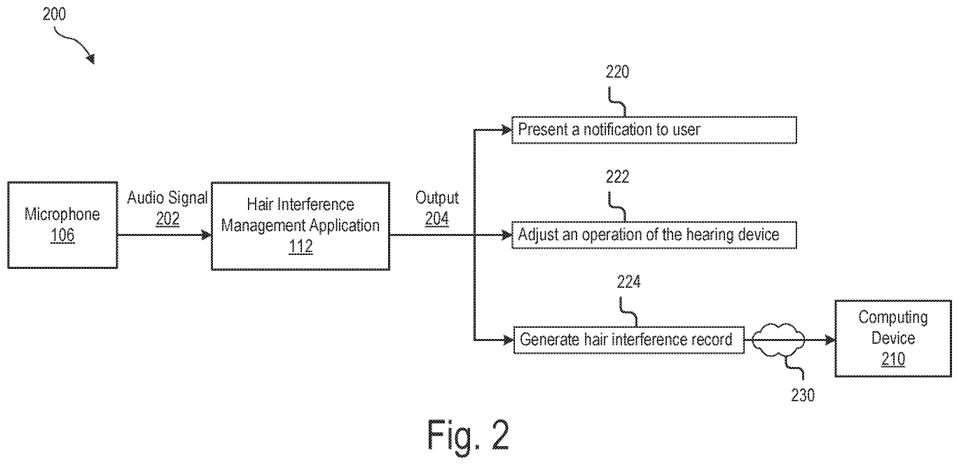

FIG. 2 shows a diagram 200 illustrating exemplary operations that may be performed by hearing device 100 of a user. In some embodiments, the user may wear hearing device 100 on a user ear and microphone 106 of hearing device 100 may capture an audio signal 202 in an ambient environment of the user. Audio signal 202 may then be provided to hair interference management application 112. In some embodiments, hair interference management application 112 may process audio signal 202 and generate an output 204 indicating whether audio signal 202 includes hair interference noise caused by a movement of user hair. If audio signal 202 includes the hair interference noise, hearing device 100 may perform one or more of operation 220, operation 222, and operation 224 as depicted in FIG. 2.

At operation 220, hearing device 100 may present a notification to the user. For example, hearing device 100 may transmit a request to a user device (e.g., a mobile phone) communicatively coupled to hearing device 100 and request the user device to display a hair interference notification to the user on the user device. The hair interference notification may indicate that the user hair interferes with operations of hearing device 100 and suggest that the user adjusts the user hair to address such interference. For example, the hearing device may connect to a user's mobile device and ask the user to take a picture of the user to determine if hair interference is indeed occurring (e.g., using digital imagine processing techniques the hearing device can determine if hear is touching or rubbing against the hearing device).

At operation 222, hearing device 100 may adjust its operations to reduce negative impacts of the hair interference noise on an output signal provided to the user. For example, hearing device 100 may at least partially remove the hair interference noise from the audio signal, adjust various operation parameters to conceal the hair interference noise, etc. The adjustments may include digital signal processing techniques designed to remove frequencies or noises associated with hair interference or applying a neural network to de-noise the hair noise interference.

At operation 224, hearing device 100 may generate a hair interference record describing the hair interference based on the hair interference noise, and transmit the hair interference record to a computing device 210 that is separate from hearing device 100. For example, hearing device 100 may transmit the hair interference record to a server (e.g., a cloud-based server, an on-premised server) associated with a clinical facility of the user via a network 230. The clinical facility may use the hair interference record to analyze the hair interference, and thereby provide effective recommendations for hearing devices to people with hearing impairments, as described herein.

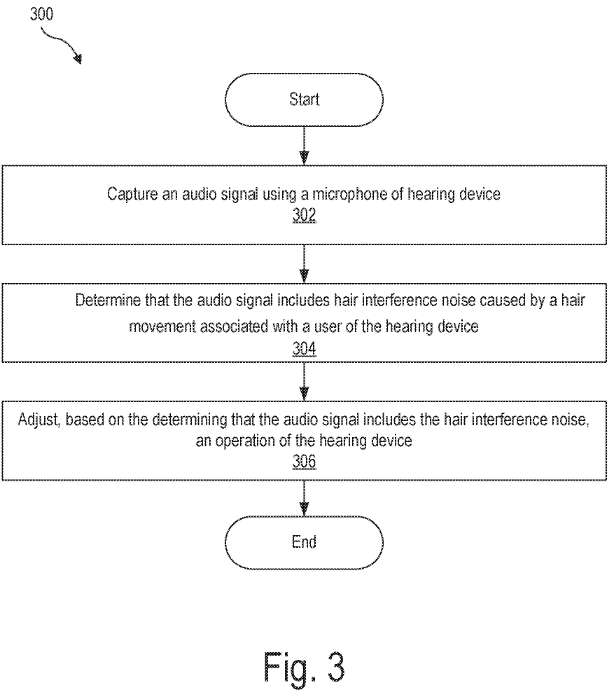

FIG. 3 illustrates an exemplary flowchart 300 depicting operations that may be performed by hearing device 100 (e.g., processor 102) according to principles described herein.

At operation 302, hearing device 100 may capture an audio signal using microphone 106 of hearing device 100. For example, a user of hearing device 100 may wear hearing device 100 on a user ear and microphone 106 may capture an audio signal in a surrounding environment of the user.

At operation 304, hearing device 100 may determine that the audio signal includes hair interference noise caused by hair movement associated with the user. The hair interference noise may be audio noise generated when user hair scrapes on or brushes against hearing device 100 due to a user action that causes the user hair to move.

At operation 306, hearing device 100 may adjust, based on the determining that the audio signal includes the hair interference noise, an operation of hearing device 100. For example, hearing device 100 may at least partially remove the hair interference noise from the audio signal, thereby improving the audio output provided to the user.

In some embodiments, to determine that the audio signal includes the hair interference noise, hearing device 100 may input the audio signal into a machine learning model. This machine learning model may be referred to herein as a first machine learning model. In some embodiments, the first machine learning model may be implemented using one or more supervised and/or unsupervised learning algorithms. For example, the first machine learning model may be implemented in the form of a linear regression model, a logistic regression model, a Support Vector Machine (SVM) model, and/or other learning models. Additionally or alternatively, the first machine learning model may be implemented in the form of a neural network including an input layer, one or more hidden layers, and an output layer. Non-limiting examples of the neural network include, but are not limited to, Convolutional Neural Network (CNN), Recurrent Neural Network (RNN), Long Short-Term Memory (LSTM) neural network, etc. Other learning model architectures for implementing the first machine learning model are also possible and can be useful.

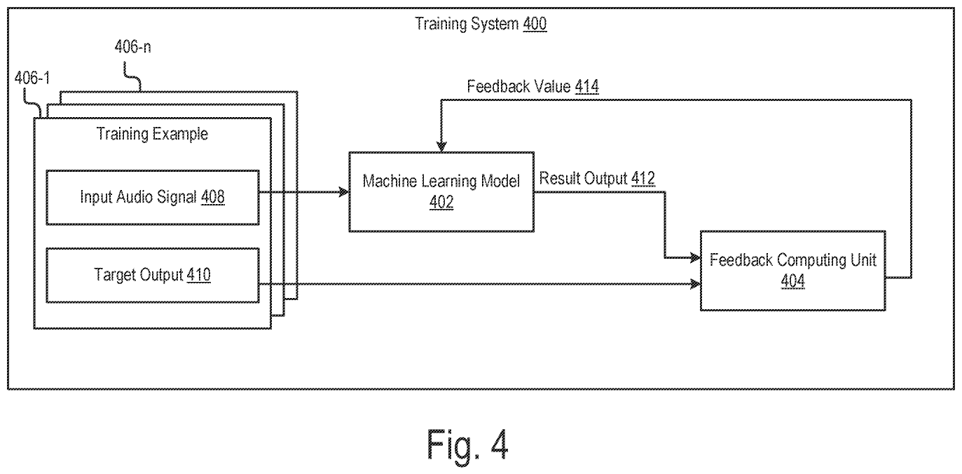

In some embodiments, the first machine learning model may generate an output for an audio signal. The output may indicate whether or not the audio signal includes hair interference noise. In some embodiments, to detect the hair interference noise in the audio signal, the first machine learning model may be subjected to a training process performed by a training system. The training system may be implemented by a computing device, hearing device 100, and/or any combination thereof. An example training system 400 for training a first machine learning model is illustrated in FIG. 4.

As depicted in FIG. 4, training system 400 may include a first machine learning model such as a machine learning model 402 and a feedback computing unit 404. In some embodiments, machine learning model 402 may be trained with a plurality of training examples 406-1 . . . 406-n (commonly referred to herein as training examples 406). As depicted in FIG. 4, each training example 406 may include data representative of an input audio signal 408 and a target output 410. In some embodiments, target output 410 may indicate a ground truth of whether or not input audio signal 408 actually includes hair interference noise. For example, if input audio signal 408 does includes hair interference noise, target output 410 may have a value of 1 (or 100%). If input audio signal 408 does not include hair interference noise, target output 410 may have a value of 0 (or 0%).

In some embodiments, to train machine learning model 402 with a training example 406 in a training cycle, training system 400 may compute, using machine learning model 402, a result output 412 for an input audio signal 408 in training example 406. For example, as depicted in FIG. 4, training system 400 may apply machine learning model 402 to input audio signal 408, and machine learning model 402 may compute result output 412 indicating whether or not input audio signal 408 includes hair interference noise. In some embodiments, result output 412 may be in a binary format in which a result output of 1 may indicate a prediction that input audio signal 408 includes hair interference noise, and a result output of 0 may indicate a prediction that input audio signal 408 does not include hair interference noise. In some embodiments, result output 412 may be in a percentage format and may indicate a predicted likelihood (e.g., 75%) that input audio signal 408 includes hair interference noise. This predicted likelihood may also be considered as a confidence level of machine learning model 402 that input audio signal 408 includes hair interference noise.

In some embodiments, training system 400 may compute a feedback value 414 based on result output 412 and target output 410. For example, as depicted in FIG. 4, training system 400 may provide result output 412 computed by machine learning model 402 and target output 410 included in training example 406 to feedback computing unit 404. As described herein, result output 412 may indicate a prediction computed by machine learning model 402 regarding whether or not input audio signal 408 includes hair interference noise, and target output 410 may indicate the ground truth of whether or not input audio signal 408 actually includes hair interference noise.

In some embodiments, feedback computing unit 404 may compute feedback value 414 based on result output 412 and target output 410. For example, feedback value 414 may be a difference value or a mean squared error between result output 412 computed by machine learning model 402 and target output 410 included in training example 406. Other implementations for computing feedback value 414 are also possible and can be useful.

In some embodiments, training system 400 may adjust one or more model parameters of machine learning model 402 based on feedback value 414. For example, as depicted in FIG. 4, training system 400 may back-propagate feedback value 414 computed by feedback computing unit 404 to machine learning model 402, and adjust the model parameters of machine learning model 402 based on feedback value 414. For example, training system 400 may adjust one or more values assigned to one or more coefficients of machine learning model 402 based on feedback value 414.

In some embodiments, training system 400 may determine whether the model parameters of machine learning model 402 have been sufficiently adjusted. For example, training system 400 may determine that machine learning model 402 has been subjected to a predetermined number of training cycles. Therefore, training system 400 may determine that machine learning model 402 has been trained with a predetermined number of training examples, and thus determine that the model parameters of machine learning model 402 have been sufficiently adjusted.

Additionally or alternatively, training system 400 may determine that feedback value 414 satisfies a predetermined feedback value threshold, and thus determine that the model parameters of machine learning model 402 have been sufficiently adjusted.

Additionally or alternatively, training system 400 may determine that feedback value 414 remains substantially unchanged for a predetermined number of training cycles (e.g., a difference between the feedback values computed in sequential training cycles satisfying a difference threshold), and thus determine that the model parameters of machine learning model 402 have been sufficiently adjusted.

In some embodiments, based on the determination that the model parameters of machine learning model 402 have been sufficiently adjusted, training system 400 may determine that the training process of machine learning model 402 is completed. Training system 400 may then select the current values of the model parameters to be the values of the model parameters in trained machine learning model 402.

In some embodiments, once machine learning model 402 is sufficiently trained, machine learning model 402 may be implemented on hearing device 100 as the first machine learning model to detect hair interference noise in an audio signal. As described herein, hearing device 100 may input the audio signal into machine learning model 402, and machine learning model 402 may generate an output indicating whether the audio signal includes hair interference noise.

For example, machine learning model 402 may generate the output in binary format. If the output has a value of 1, hearing device 100 may determine that the audio signal includes the hair interference noise. If the output has a value of 0, hearing device 100 may determine that the audio signal does not include the hair interference noise.

As another example, machine learning model 402 may generate the output in percentage format and hearing device 100 may compare the output with a percentage threshold (e.g., a predefined number of percentage). If the output is equal to or higher than the percentage threshold, hearing device 100 may determine that the audio signal includes the hair interference noise. Otherwise, hearing device 100 may determine that the audio signal does not include the hair interference noise.

In some embodiments, machine learning model 402 may be implemented not on hearing device 100 but on a separate computing device (e.g., a cloud-based server, an on-premises computer, a mobile phone, etc.) communicatively coupled to hearing device 100. In this case, hearing device 100 may transmit an audio signal captured by microphone 106 to the separate computing device. The separate computing device may use machine learning model 402 to generate an output for the audio signal, and transmit the output to hearing device 100.

In some embodiments, to determine whether an audio signal includes hair interference noise, hearing device 100 may rely on an additional microphone associated with the user instead of or in addition to relying on a machine learning model as described above. In some embodiments, the user may wear hearing device 100 and the additional microphone at the same time. In this configuration, microphone 106 of hearing device 100 and the additional microphone may simultaneously capture audio signals in the ambient environment of the user.

In some embodiments, the additional microphone may be worn or carried by the user in a manner that the additional microphone is unimpacted by user hair of the user. For example, the additional microphone may be attached to clothes of the user or integrated into an accessory item (e.g., a watch, a necklace, a bracelet, etc.) of the user so that the additional microphone is positioned at a distance from the user hair. Alternatively, the additional microphone may be a microphone of a user device (e.g., a mobile phone, a smartwatch, etc.) that is usually carried or used at a distance from the user hair. In some embodiments, the additional microphone may be communicatively coupled to hearing device 100, and therefore the additional microphone may capture audio signals and transmit the audio signals to hearing device 100.

In some embodiments, to determine whether the audio signal includes the hair interference noise, hearing device 100 may receive an additional audio signal from the additional microphone associated with the user. Hearing device 100 may then compute a similarity score between the audio signal captured by microphone 106 of hearing device 100 and the additional audio signal captured by the additional microphone. For example, hearing device 100 may compare signal representations and/or signal attributes (e.g., amplitude, frequency, phase, etc.) of the audio signal and the additional audio signal, and compute the similarity score indicating a level of similarity between the audio signal and the additional audio signal.

In some embodiments, hearing device 100 may determine that the similarity score between the audio signal and the additional audio signal satisfies a similarity score threshold. For example, hearing device 100 may determine that the similarity score between the audio signal and the additional audio signal is equal to or lower than a predefined score. Accordingly, hearing device 100 may determine that the audio signal captured by microphone 106 of hearing device 100 is relatively different from the additional audio signal captured by the additional microphone that is unimpacted by the user hair. Therefore, hearing device 100 may determine that the audio signal captured by its microphone 106 includes the hair interference noise.

In some embodiments, the comparison between the audio signal captured by microphone 106 of hearing device 100 and the additional audio signal captured by the additional microphone associated with the user may be used to verify that the audio signal includes the hair interference noise. For example, hearing device 100 may first apply the first machine learning model (e.g., machine learning model 402) to the audio signal. The first machine learning model may generate an output for the audio signal as described herein, and the output may indicate a confidence level that satisfies a first confidence threshold but does not satisfy a second confidence threshold (e.g., the output may be higher than a first predefined number of percentage, such as 50%, but lower than a second predefined number of percentage, such as 60%). Accordingly, based on the output, hearing device 100 may determine that the audio signal captured by its microphone 106 includes the hair interference noise but the confidence level of this determination is relatively low. In this case, hearing device 100 may compare the audio signal with the additional audio signal captured by the additional microphone as described above. If the similarity score between the audio signal and the additional audio signal satisfies the similarity score threshold, hearing device 100 may verify that the audio signal includes the hair interference noise with a higher level of confidence (e.g., more than 90%).

Another implementation to verify that the audio signal includes the hair interference noise is to compare the audio signal captured by microphone 106 of hearing device 100 with an additional audio signal captured by an additional microphone 106 of an additional hearing device 100 associated with the user. In some embodiments, the user may wear hearing device 100 on a first ear and an additional hearing device 100 on a second ear. In this configuration, microphone 106 of hearing device 100 and an additional microphone 106 of additional hearing device 100 may simultaneously capture audio signals in the ambient environment of the user. In some embodiments, additional hearing device 100 and/or additional microphone 106 of additional hearing device 100 may be communicatively coupled to hearing device 100 and may transmit the additional audio signal captured by additional microphone 106 to hearing device 100.

In some embodiments, hearing device 100 may receive the additional audio signal captured by additional microphone 106 of additional hearing device 100. Hearing device 100 may then compute a similarity score between the audio signal captured by microphone 106 of hearing device 100 and the additional audio signal captured by additional microphone 106 of additional hearing device 100. For example, hearing device 100 may compare signal representations and/or signal attributes (e.g., amplitude, frequency, phase, etc.) of the audio signal and the additional audio signal, and compute the similarity score indicating a level of similarity between the audio signal and the additional audio signal.

In some embodiments, hearing device 100 may determine that the similarity score between the audio signal and the additional audio signal satisfies a similarity score threshold. For example, hearing device 100 may determine that the similarity score between the audio signal and the additional audio signal is equal to or higher than a predefined score. Accordingly, hearing device 100 may determine that the audio signal captured by microphone 106 of hearing device 100 is relatively similar to the additional audio signal captured by additional microphone 106 of additional hearing device 100. As a result, hearing device 100 may verify that the audio signal captured by its microphone 106 includes the hair interference noise, because the user hair may likely impact both hearing device 100 and additional hearing device 100 on both ears of the user similarly.

In some embodiments, to determine or verify that the audio signal includes the hair interference noise, hearing device 100 may further rely on hair data of the user. In some embodiments, the hair data may describe user hair of the user. For example, the hair data may indicate a hair length category of the user hair (e.g., long hair or short hair), a hair arrangement of the user hair (e.g., the user wears hair up or down, the user has the same hair length or different hair lengths on a left side and a right side of user head), a relative position of hearing device 100 and/or its components relative to the user hair (e.g., hearing device 100 is covered or uncovered by the user hair, relative angle between microphone 106 and the user hair, etc.), etc. Other types of hair data are also possible and can be useful.

In some embodiments, hearing device 100 may store the hair data of the user in its memory 104. Additionally or alternatively, hearing device 100 may receive the hair data of the user from another computing device. For example, hearing device 100 may receive a user profile including the hair data of the user from a server associated with a clinical facility of the user. As another example, hearing device 100 may receive the hair data of the user from a user device (e.g., a mobile phone) of the user. In some embodiments, the user device may receive or capture an image of the user, and detect a user face and user hair of the user in the image using a facial recognition technique and/or other image processing operations. The user device may then generate the hair data describing the user hair of the user as depicted in the image. In some embodiments, the user device may receive user inputs describing a current hairstyle of the user, and generate the hair data of the user based on the user inputs.

In some embodiments, to determine that the audio signal includes the hair interference noise, hearing device 100 may reference the hair data of the user and evaluate the impact of the user hair on hearing device 100 based on the hair data. For example, hearing device 100 may determine that the user hair is long and covers hearing device 100. Therefore, hearing device 100 may determine that the audio signal captured by microphone 106 of hearing device 100 likely includes the hair interference noise.

In some embodiments, hearing device 100 may determine that the audio signal includes the hair interference noise as described herein, and then verify that the audio signal includes the hair interference noise based on the hair data of the user. For example, to verify that the audio signal includes the hair interference noise, hearing device 100 may compare the audio signal captured by microphone 106 of hearing device 100 on the first ear of the user with the additional audio signal captured by additional microphone 106 of additional hearing device 100 on the second ear of the user as described herein. Hearing device 100 may also reference the hair data of the user.

In some embodiments, if the hair data of the user indicates that the user has the same hair length on both sides of the user head, hearing device 100 may determine that the user hair may likely impact both hearing device 100 and additional hearing device 100 on both ears of the user. In this case, if the comparison between the audio signal and the additional audio signal indicates that the audio signal captured by hearing device 100 is relatively similar to the additional audio signal captured by additional hearing device 100, hearing device 100 may verify that the audio signal includes the hair interference noise.

In some embodiments, if the hair data of the user indicates that the user has different hair lengths on different sides of the user head, hearing device 100 may determine that the user hair may likely impact hearing device 100 on the first ear of the user but may not impact additional hearing device 100 on the second ear of the user or vice versa. In this case, if the comparison between the audio signal and the additional audio signal indicates that the audio signal captured by hearing device 100 is relatively different from the additional audio signal captured by additional hearing device 100, hearing device 100 may verify that the audio signal includes the hair interference noise.

In some embodiments, for other combinations of comparison results and hair data of the user, hearing device 100 may not verify that the audio signal includes the hair interference noise.

In some embodiments, once hearing device 100 determines and/or verifies that an audio signal captured by its microphone 106 includes hair interference noise, hearing device 100 may adjust its operation accordingly. For example, hearing device 100 may determine a signal attribute (e.g., amplitude, frequency, phase, etc.) of the hair interference noise included in the audio signal. Hearing device 100 may then at least partially remove the hair interference noise from the audio signal and/or adjust operation parameters of hearing device 100 to mask the hair interference noise based on the signal attribute of the hair interference noise.

In some embodiments, to determine the signal attribute of the hair interference noise in the audio signal, hearing device 100 may input the audio signal into a machine learning model. This machine learning model may be referred to herein as a second machine learning model. In some embodiments, the second machine learning model may be implemented using one or more supervised and/or unsupervised learning algorithms. For example, the second machine learning model may be implemented in the form of a linear regression model, a logistic regression model, a SVM model, and/or other learning models. Additionally or alternatively, the second machine learning model may be implemented in the form of a neural network (e.g., CNN, RNN, LSTM neural network, etc.). Other learning model architectures for implementing the second machine learning model are also possible and can be useful.

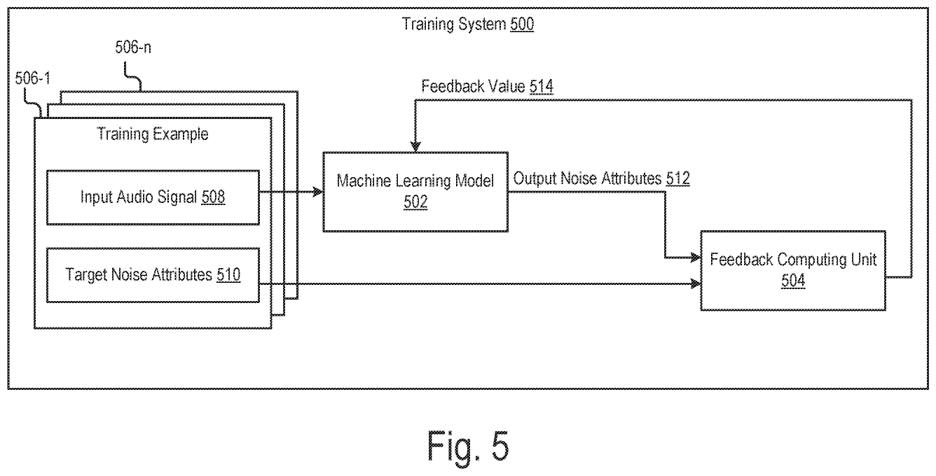

In some embodiments, the second machine learning model may generate an output for an audio signal. The output may include one or more signal attributes of hair interference noise included in the audio signal. Non-limiting examples of the signal attribute include, but are not limited to, an amplitude of the hair interference noise, a frequency of the hair interference noise, a phase of the hair interference noise, etc. In some embodiments, to determine the signal attribute of the hair interference noise in the audio signal, the second machine learning model may be subjected to a training process performed by a training system. The training system may be implemented by a computing device, hearing device 100, and/or any combination thereof. An example training system 500 for training a second machine learning model is illustrated in FIG. 5.

As depicted in FIG. 5, training system 500 may include a second machine learning model such as a machine learning model 502 and a feedback computing unit 504. In some embodiments, machine learning model 502 may be trained with a plurality of training examples 506-1 . . . 506-n (commonly referred to herein as training examples 506). As depicted in FIG. 5, each training example 506 may include an input audio signal 508 and target noise attributes 510. In some embodiments, target noise attributes 510 may include one or more signal attributes of hair interference noise included in input audio signal 508. For example, target noise attributes 510 may include an actual amplitude of the hair interference noise, an actual frequency of the hair interference noise, an actual phase of the hair interference noise, etc.

In some embodiments, to train machine learning model 502 with a training example 506 in a training cycle, training system 500 may compute, using machine learning model 502, output noise attributes 512 for an input audio signal 508 in training example 506. For example, as depicted in FIG. 5, training system 500 may apply machine learning model 502 to input audio signal 508, and machine learning model 502 may compute output noise attributes 512 of the hair interference noise in input audio signal 508. In some embodiments, output noise attributes 512 may include one or more signal attributes of the hair interference noise that machine learning model 502 determines based on input audio signal 508.

In some embodiments, training system 500 may compute a feedback value 514 based on output noise attributes 512 and target noise attributes 510. For example, as depicted in FIG. 5, training system 500 may provide output noise attributes 512 computed by machine learning model 502 and target noise attributes 510 included in training example 506 to feedback computing unit 504. As described herein, output noise attributes 512 may include one or more signal attributes of the hair interference noise in input audio signal 508 that are computed by machine learning model 502, and target noise attributes 510 may include one or more actual signal attributes of the hair interference noise in input audio signal 508.

In some embodiments, feedback computing unit 504 may compute feedback value 514 based on output noise attributes 512 and target noise attributes 510. For example, feedback value 514 may be a mean squared error between the signal attributes of the hair interference noise in output noise attributes 512 that are computed by machine learning model 502 and the actual signal attributes of the hair interference noise in target noise attributes 510 that are included in training example 506. Other implementations for computing feedback value 514 are also possible and can be useful.

In some embodiments, training system 500 may adjust one or more model parameters of machine learning model 502 based on feedback value 514. For example, as depicted in FIG. 5, training system 500 may back-propagate feedback value 514 computed by feedback computing unit 504 to machine learning model 502, and adjust the model parameters of machine learning model 502 based on feedback value 514. For example, training system 500 may adjust one or more values assigned to one or more coefficients of machine learning model 502 based on feedback value 514.

In some embodiments, training system 500 may determine whether the model parameters of machine learning model 502 have been sufficiently adjusted. In some embodiments, the manners in which training system 500 may determine whether the model parameters of machine learning model 502 have been sufficiently adjusted may be similar to the manners in which training system 400 may determine whether the model parameters of machine learning model 402 have been sufficiently adjusted as described herein. For example, training system 500 may determine that machine learning model 502 has been subjected to a predetermined number of training cycles. As another example, training system 500 may determine that feedback value 514 satisfies a predetermined feedback value threshold. As another example, training system 500 may determine that feedback value 514 remains substantially unchanged for a predetermined number of training cycles. Based on one or more of these determinations, training system 500 may determine that the model parameters of machine learning model 502 have been sufficiently adjusted. Accordingly, training system 500 may determine that the training process of machine learning model 502 is completed, and select the current values of the model parameters to be the values of the model parameters in trained machine learning model 502.

In some embodiments, once machine learning model 502 is sufficiently trained, machine learning model 502 may be implemented on hearing device 100 as the second machine learning model to determine one or more signal attributes of hair interference noise included in an audio signal. As described herein, hearing device 100 may input an audio signal captured by its microphone 106 into machine learning model 502, and machine learning model 502 may generate an output including one or more signal attributes of the hair interference noise in the audio signal. In some embodiments, machine learning model 502 may be implemented not on hearing device 100 but on a separate computing device (e.g., a cloud-based server, an on-premises computer, a mobile phone, etc.) communicatively coupled to hearing device 100. In this case, hearing device 100 may transmit an audio signal captured by its microphone 106 to the separate computing device. The separate computing device may use machine learning model 502 to generate an output for the audio signal, and transmit the output to hearing device 100.

In some embodiments, to determine a signal attribute of hair interference noise included in an audio signal, hearing device 100 may perform other operations instead of relying on a machine learning model as described above. As an example, hearing device 100 may analyze a signal representation of the audio signal to identify the hair interference noise in the audio signal. The hair interference noise may be a portion of the audio signal that has its signal attribute (e.g., amplitude, frequency, etc.) significantly different from other portions of the audio signal. Additionally or alternatively, the hair interference noise may be a portion of the audio signal that has its signal attribute outside a value range of that signal attribute for human speech. Once the hair interference noise in the audio signal is identified, hearing device 100 may analyze the hair interference noise to determine one or more signal attributes (e.g., amplitude, frequency, phase, etc.) of the hair interference noise. Other implementations to determine the signal attribute of the hair interference noise are also possible and can be useful.

In some embodiments, to reduce negative impacts of the hair interference noise, hearing device 100 may at least partially remove the hair interference noise from the audio signal captured by microphone 106 of hearing device 100 to generate an output audio signal. Hearing device 100 may then provide the output audio signal to the user of hearing device 100. In some embodiments, hearing device 100 may remove the hair interference noise partially or entirely from the audio signal based on the signal attribute of the hair interference noise described above. For example, hearing device 100 may filter a portion that has the frequency of the hair interference noise from the audio signal. As another example, hearing device 100 may filter one or more portions of the audio signal that have an amplitude equal to or lower than the amplitude of the hair interference noise from the audio signal. As a result, impacts of the hair interference noise on the output audio signal provided to the user may be reduced or minimized, and therefore a user experience with hearing device 100 may be improved.

In some embodiments, to reduce negative impacts of the hair interference noise, hearing device 100 may adjust its operation parameters based on the signal attribute of the hair interference noise to mask the hair interference noise in the audio signal. For example, hearing device 100 may adjust its operation parameters to amplify amplitudes of other portions in the audio signal relative to the amplitude of the hair interference noise to hide or conceal the hair interference noise. As another example, hearing device 100 may adjust its operation parameters to generate a cancelling signal that is out of phase with the hair interference noise. The cancelling signal may collide with the hair interference noise and cancel out the hair interference noise. As a result, impacts of the hair interference noise on the output audio signal provided to the user may be reduced or eliminated, and therefore user experience with hearing device 100 may be improved. Other implementations to adjust operations of hearing device 100 based on the hair interference noise are also possible and can be useful.

In some embodiments, hearing device 100 may be configured with one or more classifiers (also referred to herein as classifier modes). A classifier is a software program or algorithm, which when executed by the processor of the hearing device, causes the hearing device to classify the sound received by the hearing device (e.g., speech, speech-in-noise, quiet, wind noise) and apply a mode of operation to adjust an output signal of the hearing device based on the classifier. In some embodiments, a particular classifier (e.g., a wind classifier, a speech noise classifier, etc.) may correspond to a particular environment condition (e.g., windy environment, indoor environment, etc.) in which hearing device 100 may operate. The classifier may specify value ranges for signal attributes of noise (e.g., wind noise, background speech noise, etc.) that usually presents in the environment condition. The classifier may also specify configurations and/or operations of hearing device 100 to address such noise. In some embodiments, the classifier may specify specific commands for the digital signal processor of the hearing device or control how the digital signal processor operates to adjust operation of the hearing device to the sound environment detected by the classifier.

In some embodiments, hearing device 100 may be configured with a hair classifier. The hair classifier may correspond to an environment condition of moving hair and may specify value ranges for signal attributes of hair interference noise that usually presents in this environment condition. The hair classifier may also specify configurations and/or operations of hearing device 100 described herein to at least partially remove, mask, or otherwise address the hair interference noise. In some embodiments, one or more classifiers (e.g., the hair classifier, the wind classifier, etc.) may be simultaneously applied to operations performed by hearing device 100 to address various types of noise (e.g., hair interference noise, wind noise, etc.) included in an audio signal captured by microphone 106 of hearing device 100.

While certain examples presented herein are described in relation to an audio signal captured by microphone 106 of hearing device 100, the operations described herein may also be applicable to other signals such as an accelerometer signal generated by accelerometer 108 of hearing device 100. As described herein, accelerometer 108 may be configured to detect a user movement (e.g., a head turn) of the user by detecting a movement of hearing device 100. The user movement may cause the user hair to move and such hair movement may cause hair interference noise.

In some embodiments, the determination that the audio signal includes the hair interference noise may further be based on the user movement detected by accelerometer 108. For example, the first machine learning model (e.g., machine learning model 402) described herein may be trained with accelerometer signals generated by accelerometer 108 that are corresponding to audio signals captured by microphone 106. Such an accelerometer signal may be generated by accelerometer 108 when a corresponding audio signal is captured by microphone 106. Accordingly, the first machine learning model may learn to detect hair interference noise in an audio signal based on an accelerometer signal corresponding to the audio signal. Alternatively, both the audio signals captured by microphone 106 and the accelerometer signals generated by accelerometer 108 may be used to train the first machine learning model. Accordingly, the first machine learning model may learn to detect hair interference noise in an audio signal based on both the audio signal and an accelerometer signal corresponding to the audio signal. Similarly, the second machine learning model (e.g., machine learning model 502) may also be trained to determine a signal attribute of hair interference noise in an audio signal based on an accelerometer signal corresponding to the audio signal or based on both the audio signal and the accelerometer signal.

In some embodiments, when hearing device 100 detects hair interference noise in an audio signal captured by its microphone 106, hearing device 100 may generate a hair interference record based on the hair interference noise. The hair interference record may describe hair interference of user hair that causes the hair interference noise. In some embodiments, the hair interference record may include a hair interference timestamp at which the hair interference noise is detected, one or more classifier modes of hearing device 100 (e.g., wind classifier and/or other classifiers that are applied by hearing device 100) when the hair interference noise is detected, one or more signal attributes (e.g., amplitude, frequency, phase, etc.) of the hair interference noise, and/or other information related to the hair interference noise.

In some embodiments, hearing device 100 may transmit the hair interference record to a separate computing device via a communication network. For example, hearing device 100 may transmit the hair interference record via the communication network to a computing device communicatively coupled to hearing device 100 such as a server associated with a clinical facility of the user. In some embodiments, the computing device may receive multiple hair interference records from various hearing devices 100. The computing device may use these hair interference records to evaluate impacts of hair interference on various hearing devices 100. These hearing devices 100 may have their microphone 106 located at different positions and may be used by users having different hairstyles. In some embodiments, based on the impacts of hair interference on different hearing devices 100 used by different users, the computing device may effectively provide a recommendation for a hearing device and/or for a customized option of a hearing device to a particular user.

In some embodiments, to evaluate impacts of hair interference on a hearing device 100 for a user, the computing device may input a hearing device profile of hearing device 100 and a user profile of the user into a machine learning model. This machine learning model may be referred to herein as a third machine learning model. In some embodiments, the third machine learning model may be implemented using one or more supervised and/or unsupervised learning algorithms. For example, the third machine learning model may be implemented in the form of a linear regression model, a logistic regression model, a SVM model, and/or other learning models. Additionally or alternatively, the third machine learning model may be implemented in the form of a neural network (e.g., CNN, RNN, LSTM neural network, etc.). Other learning model architectures for implementing the third machine learning model are also possible and can be useful.

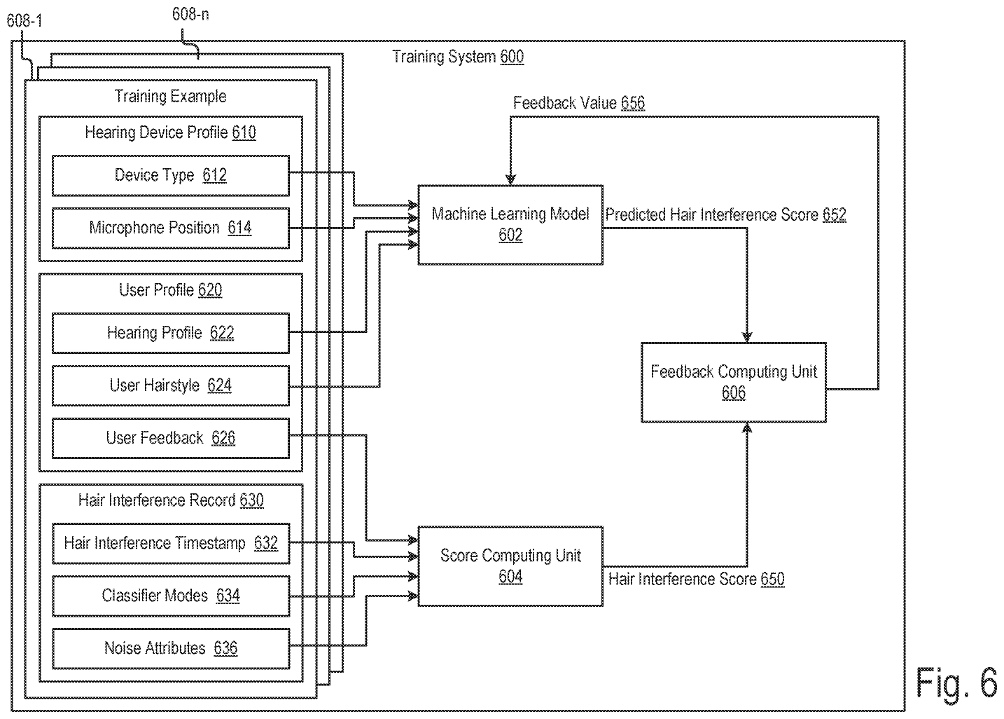

In some embodiments, the third machine learning model may generate an output for an input dataset including a hearing device profile of hearing device 100 and a user profile of a user. In some embodiments, the output may include a hair interference score predicted for the user and the hearing device 100. The hair interference score may indicate a level of interference by user hair of the user with operations of hearing device 100 when the user wears hearing device 100. In some embodiments, to compute a hair interference score for a user and a hearing device 100, the third machine learning model may be subjected to a training process performed by a training system. The training system may be implemented by a computing device such as the server associated with the clinical facility and/or any other computing device. An example training system 600 for training a third machine learning model is illustrated in FIG. 6.

As depicted in FIG. 6, training system 600 may include a third machine learning model such as a machine learning model 602, a score computing unit 604, and a feedback computing unit 606. In some embodiments, machine learning model 602 may be trained with a plurality of training examples 608-1 . . . 608-n (commonly referred to herein as training examples 608). Each training example 608 may correspond to a hearing device 100 and a user using hearing device 100. As depicted in FIG. 6, training example 608 may include a hearing device profile 610 of hearing device 100, a user profile 620 of the user, and a hair interference record 630 generated by hearing device 100.

In some embodiments, hearing device profile 610 may include information about hearing device 100. As depicted in FIG. 6, hearing device profile 610 may include a device type 612 and a microphone position 614.

Device type 612 may indicate a type of hearing device (e.g., BTE, ITE, CIC, cochlear implant, etc.) in which hearing device 100 is categorized.

Microphone position 614 may indicate a relative position of microphone 106 of hearing device 100. For example, microphone position 614 may indicate an angle or a distance between microphone 106 and one or more predefined reference points on hearing device 100.

Other information (e.g., a device model, fitting parameters, etc.) of hearing device 100 may also be included in hearing device profile 610.

In some embodiments, user profile 620 may include information about the user that uses hearing device 100. As depicted in FIG. 6, user profile 620 may include a hearing profile 622, user hairstyle 624, and user feedback 626.

Hearing profile 622 may include data related to hearing capability of the user. For example, hearing profile 622 may include etiology data describing hearing impairment of the user, a usage pattern of the user in using hearing device 100, hearing performance results of the user with and without hearing device 100, etc.

User hairstyle 624 may include hair data describing user hair of the user. As described herein, the hair data of the user may include a hair length category of the user hair (e.g., long hair or short hair), a hair arrangement of the user hair (e.g., the user wears hair up or down, the user has the same hair length or different hair lengths on a left side and a right side of user head), etc.

User feedback 626 may include feedback of the user related to user experience with hearing device 100. For example, user feedback 626 may include a rating score provided by the user for hearing device 100, a positive comment (e.g., “clear output audio signal”) provided by the user regarding operations of hearing device 100, a negative comment (e.g., “wind classifier does not work, output audio signal still includes wind noise”) provided by the user regarding operations of hearing device 100, etc.

Other information of the user may also be included in user profile 620.

In some embodiments, hair interference record 630 may include information about hair interference of user hair that causes hair interference noise in an audio signal captured by hearing device 100. As described herein, hair interference record 630 may be generated by hearing device 100 when the hair interference noise is detected in the audio signal. As depicted in FIG. 6, hair interference record 630 may include a hair interference timestamp 632, classifier modes 634, and noise attributes 636.

Hair interference timestamp 632 may indicate a timestamp at which the hair interference noise is detected.

Classifier modes 634 may indicate one or more classifiers (e.g., the wind classifier, etc.) that are applied by hearing device 100 when the hair interference noise is detected.

Noise attributes 636 may indicate one or more signal attributes (e.g., amplitude, frequency, phase, etc.) of the hair interference noise.

Other information about the hair interference may also be included in hair interference record 630.

In some embodiments, to train machine learning model 602 with a training example 608 in a training cycle, training system 600 may compute, using score computing unit 604, a hair interference score 650 for the hair interference in training example 608. Hair interference score 650 may indicate a level of interference by user hair of the user with operations of hearing device 100 as reflected in training example 608. As depicted in FIG. 6, training system 600 may provide hair interference timestamp 632, classifier modes 634, noise attributes 636 in hair interference record 630 and user feedback 626 in user profile 620 to score computing unit 604. Accordingly, score computing unit 604 may compute hair interference score 650 based on the data in hair interference record 630 that describes the hair interference and user feedback 626 that is provided by the user.

As an example, score computing unit 604 may analyze hair interference timestamp 632 in training example 608 and in other training examples 608 associated with hearing device 100 and the user, and determine an occurrence pattern in which hair interference occurs when the user uses hearing device 100. In some embodiments, score computing unit 604 may compute hair interference score 650 based on the occurrence pattern of hair interference. For example, hair interference score 650 may be proportional (e.g., directly proportional) to an occurrence frequency at which hair interference occurs.

Additionally or alternatively, score computing unit 604 may analyze noise attributes 636 of the hair interference noise, and compute hair interference score 650 based on noise attributes 636 of the hair interference noise. For example, hair interference score 650 may be proportional (e.g., directly proportional) to an amplitude of the hair interference noise and/or proportional (e.g., directly proportional) to a frequency difference between a frequency of the hair interference noise and an average frequency of human speech.

Additionally or alternatively, score computing unit 604 may analyze classifier modes 634 and user feedback 626, and compute hair interference score 650 based on classifier modes 634 and user feedback 626. For example, classifier modes 634 may indicate that hearing device 100 applies a wind classifier when the hair interference noise is detected, and user feedback 626 may include a negative comment provided by the user about the wind classifier not working effectively. In this case, because a windy environment usually causes hair movement, wind noise is usually accompanied by hair interference noise and negative impacts to an output audio signal provided to the user may actually be caused by such hair interference noise. To reflect impacts of the hair interference noise detected by hearing device 100 given user feedback 626, score computing unit 604 may increase hair interference score 650 that is computed based on other factors. For example, computing unit 604 may increase hair interference score 650 by a predefined amount or multiply hair interference score 650 by a predefined coefficient.

In some embodiments, to train machine learning model 602 with training example 608, training system 600 may also compute, using machine learning model 602, a predicted hair interference score 652 for the hair interference in training example 608. Predicted hair interference score 652 may indicate a level of interference by user hair of the user with operations of hearing device 100 as predicted by machine learning model 602. As depicted in FIG. 6, training system 600 may provide device type 612 and microphone position 614 in hearing device profile 610 and hearing profile 622 and user hairstyle 624 in user profile 620 to machine learning model 602. Accordingly, machine learning model 602 may compute predicted hair interference score 652 based on the data related to hearing device 100 in hearing device profile 610 and the data related to the user in user profile 620.

In some embodiments, training system 600 may compute a feedback value 656 based on predicted hair interference score 652 and hair interference score 650. For example, as depicted in FIG. 6, training system 600 may input predicted hair interference score 652 computed by machine learning model 602 and hair interference score 650 computed by score computing unit 604 into feedback computing unit 606. As described herein, predicted hair interference score 652 may indicate a level of interference by user hair of the user with operations of hearing device 100 as predicted by machine learning model 602, and hair interference score 650 may indicate a level of interference by user hair of the user with operations of hearing device 100 as reflected by hair interference record 630 and user feedback 626 in training example 608.

In some embodiments, feedback computing unit 606 may compute feedback value 656 based on predicted hair interference score 652 and hair interference score 650. For example, feedback value 656 may be a difference value or a mean squared error between predicted hair interference score 652 predicted by machine learning model 602 and hair interference score 650 computed by score computing unit 604. Other implementations for computing feedback value 656 are also possible and can be useful.

In some embodiments, training system 600 may adjust one or more model parameters of machine learning model 602 based on feedback value 656. For example, as depicted in FIG. 6, training system 600 may back-propagate feedback value 656 computed by feedback computing unit 606 to machine learning model 602, and adjust the model parameters of machine learning model 602 based on feedback value 656. For example, training system 600 may adjust one or more values assigned to one or more coefficients of machine learning model 602 based on feedback value 656.

In some embodiments, score computing unit 604 may also be implemented as a machine learning model (e.g., a fourth machine learning model) and training system 600 may also adjust one or more model parameters of the fourth machine learning model based on feedback value 656. For example, training system 600 may back-propagate feedback value 656 to both machine learning model 602 and score computing unit 604. Training system 600 may adjust the model parameters of machine learning model 602 and the model parameters of score computing unit 604 implemented as the fourth machine learning model based on feedback value 656.

In some embodiments, training system 600 may determine whether the model parameters of machine learning model 602 have been sufficiently adjusted. In some embodiments, the manners in which training system 600 may determine whether the model parameters of machine learning model 602 have been sufficiently adjusted may be similar to the manners in which training system 400 may determine whether the model parameters of machine learning model 402 have been sufficiently adjusted as described herein. For example, training system 600 may determine that machine learning model 602 has been subjected to a predetermined number of training cycles. As another example, training system 600 may determine that feedback value 656 satisfies a predetermined feedback value threshold. As another example, training system 600 may determine that feedback value 656 remains substantially unchanged for a predetermined number of training cycles. Based on one or more of these determinations, training system 600 may determine that the model parameters of machine learning model 602 have been sufficiently adjusted. Accordingly, training system 600 may determine that the training process of machine learning model 602 is completed, and select the current values of the model parameters to be the values of the model parameters in trained machine learning model 602.

In some embodiments, once machine learning model 602 is sufficiently trained, machine learning model 602 may be implemented on a computing device (e.g., a server associated with a clinical facility of the user) as the third machine learning model to generate a predicted hair interfering score for a user and a hearing device 100. As described herein, the computing device may input a hearing device profile 610 including a device type 612 and a microphone position 614 of hearing device 100 and user profile 620 including hearing profile 622 and user hairstyle 624 of the user into machine learning model 602, and machine learning model 602 may generate a predicted hair interfering score for the user and hearing device 100. The predicted hair interfering score may indicate a predicted level of interference by user hair of the user with operations of hearing device 100 when the user uses hearing device 100.

In some embodiments, the computing device may use machine learning model 602 to generate predicted hair interfering scores for the user and various hearing devices 100. For example, the computing device may input user profile 620 of the user and hearing device profile 610 of various hearing devices 100 into machine learning model 602, and machine learning model 602 may generate a predicted hair interfering score for the user and each hearing device 100.

In some embodiments, the computing device may present the predicted hair interfering scores computed for the user and various hearing devices 100 to a hearing specialist (e.g., an audiologist and/or other healthcare provider of a clinical facility associated with the user) on a display screen. The hearing specialist may reference the predicted hair interfering scores, and provide a recommendation for hearing devices 100 to the user based on predicted levels of hair interference corresponding to these hearing devices 100 as indicated by the predicted hair interfering scores. For example, the hearing specialist may suggest that the user uses a hearing device 100 that has a relatively low predicted hair interfering score. Additionally or alternatively, the hearing specialist may provide a recommendation for customized options of hearing devices 100 to the user based on the predicted hair interfering scores. For example, the hearing specialist may suggest adjusting a microphone position of a particular hearing device 100 based on a microphone position of another hearing device 100 that has a relatively low predicted hair interfering score, and therefore impacts of the hair interference by user hair of the user with operations of particular hearing device 100 can be reduced.

In some embodiments, instead of generating and presenting the predicted hair interfering scores computed for the user and hearing devices 100 to the hearing specialist as described above, the computing device may present hair interference records 630 generated by hearing devices 100 to the hearing specialist. In this case, the hearing specialist may reference hair interference records 630, hearing device profiles 610 of hearing devices 100, user profile 620 of the user, and provide a recommendation for hearing devices 100 and/or for customized options of hearing devices 100 to the user based on this data accordingly.

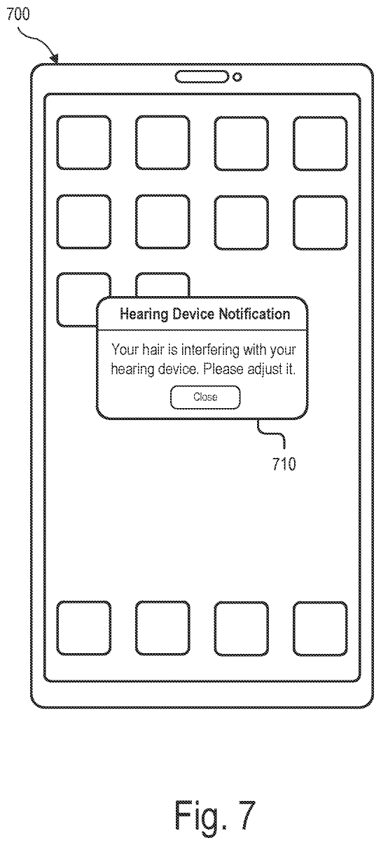

FIG. 7 illustrates a user interface 700 including an example notification that is presented to the user when hair interference noise is detected in an audio signal captured by microphone 106 of hearing device 100 as described herein. In some embodiments, user interface 700 may be displayed on a user device (e.g., a mobile phone, a laptop, a tablet, etc.) associated with the user and communicatively coupled to hearing device 100 of the user. As depicted in FIG. 7, user interface 700 may include a hair interference notification 710.

In some embodiments, when hearing device 100 determines that an audio signal captured by its microphone 106 includes hair interference noise, hearing device 100 may provide a hair interference notification to the user. For example, hearing device 100 may transmit a notification request to the user device of the user and request the user device to display the hair interference notification to the user on the user device. In response to the notification request, the user device may display hair interference notification 710 to the user on its display screen. As depicted in FIG. 7, hair interference notification 710 may indicate that user hair of the user interferes with operations of hearing device 100 and suggest that the user adjusts the user hair to address such interference (e.g., “Your hair is interfering with your hearing device. Please adjust it.”). Accordingly, the user may be informed about the hair interference noise in the audio signal without incorrectly recognizing it as other types of noise. The user may also be able to timely adjust his or her hair to address the hair interference, and therefore audio signals captured by microphone 106 of hearing device 100 may be improved.

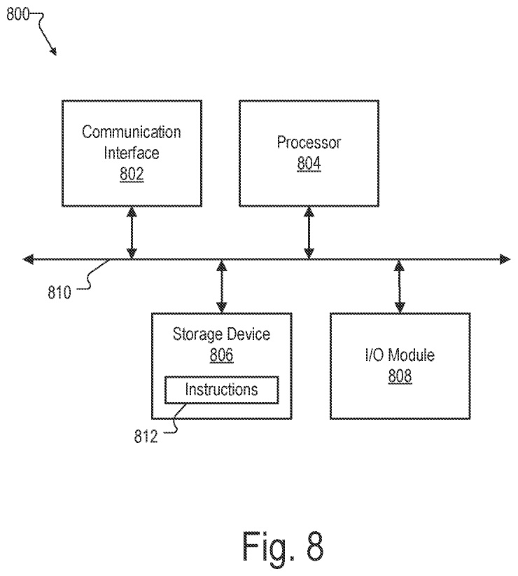

FIG. 8 illustrates an exemplary computing device 800 that may be specifically configured to perform one or more of the processes described herein. As shown in FIG. 8, computing device 800 may include a communication interface 802, a processor 804, a storage device 806, and an input/output (“I/O”) module 808 communicatively connected one to another via a communication infrastructure 810. While an exemplary computing device 800 is shown in FIG. 8, the components illustrated in FIG. 8 are not intended to be limiting. Additional or alternative components may be used in other embodiments. Components of computing device 800 shown in FIG. 8 will now be described in additional detail.

Communication interface 802 may be configured to communicate with one or more computing devices. Examples of communication interface 802 include, without limitation, a wired network interface (such as a network interface card), a wireless network interface (such as a wireless network interface card), a modem, an audio/video connection, and any other suitable interface.

Processor 804 generally represents any type or form of processing unit capable of processing data and/or interpreting, executing, and/or directing execution of one or more of the instructions, processes, and/or operations described herein. Processor 804 may perform operations by executing computer-executable instructions 812 (e.g., an application, software, code, and/or other executable data instance) stored in storage device 806.

Storage device 806 may include one or more data storage media (e.g., non-transitory computer-readable storage media), devices, or configurations and may employ any type, form, and combination of data storage media and/or device. For example, storage device 806 may include, but is not limited to, any combination of the non-volatile media and/or volatile media described herein. Electronic data, including data described herein, may be temporarily and/or permanently stored in storage device 806. For example, data representative of computer-executable instructions 812 configured to direct processor 804 to perform any of the operations described herein may be stored within storage device 806. In some examples, data may be arranged in one or more databases residing within storage device 806.

I/O module 808 may include one or more I/O modules configured to receive user input and provide user output. I/O module 808 may include any hardware, firmware, software, or combination thereof supportive of input and output capabilities. For example, I/O module 808 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 808 is configured to provide graphical data to a display for presentation to a user. The graphical data may be representative of one or more graphical user interfaces and/or any other graphical content as may serve a particular implementation.

In some examples, any of the systems, hearing devices, and/or other components described herein may be implemented by computing device 800. For example, memory 104 may be implemented by storage device 806, and processor 102 may be implemented by processor 804.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A hearing device comprising:
a microphone configured to capture an audio signal; and
a processor communicatively coupled to the microphone, the processor configured to:
determine that the audio signal includes hair interference noise caused by hair movement associated with a user of the hearing device; and
adjust, based on the determining that the audio signal includes the hair interference noise, an operation of the hearing device.

2. The hearing device of claim 1, wherein the determining that the audio signal includes the hair interference noise includes:
inputting the audio signal into a machine learning model to generate an output for the audio signal, the output indicating that the audio signal includes the hair interference noise.

3. The hearing device of claim 2, wherein the machine learning model is trained using a training example from a plurality of training examples by:
computing, using the machine learning model, a result output for an input audio signal included in the training example;
computing a feedback value based on the result output and a target output included in the training example; and
adjusting a model parameter of the machine learning model based on the feedback value.

4. The hearing device of claim 1, wherein the determining that the audio signal includes the hair interference noise includes:
receiving an additional audio signal captured by an additional microphone associated with the user, the additional microphone being unimpacted by user hair of the user;
computing a similarity score between the audio signal and the additional audio signal;
determining that the similarity score between the audio signal and the additional audio signal satisfies a similarity score threshold; and
determining, based on the determining that the similarity score satisfies the similarity score threshold, that the audio signal includes the hair interference noise.

5. The hearing device of claim 1, wherein the processor is further configured to:
receive an additional audio signal captured by an additional microphone of an additional hearing device associated with the user;
compute a similarity score between the audio signal and the additional audio signal;
determine that the similarity score between the audio signal and the additional audio signal satisfies a similarity score threshold; and
verify, based on the determining that the similarity score satisfies the similarity score threshold, that the audio signal includes the hair interference noise.

6. The hearing device of claim 1, wherein the adjusting of the operation of the hearing device includes:
determining a signal attribute of the hair interference noise;
at least partially removing, based on the signal attribute of the hair interference noise, the hair interference noise from the audio signal to generate an output audio signal; and
providing the output audio signal to the user of the hearing device.

7. The hearing device of claim 6, wherein the determining of the signal attribute of the hair interference noise includes:
inputting the audio signal into a machine learning model to determine the signal attribute of the hair interference noise included in the audio signal.

8. The hearing device of claim 1, wherein the adjusting of the operation of the hearing device includes:
determining a signal attribute of the hair interference noise; and
adjusting, based on the signal attribute of the hair interference noise, an operation parameter of the hearing device to mask the hair interference noise.

9. The hearing device of claim 1, wherein the adjusting of the operation of the hearing device includes:
applying a hair classifier mode configured to address the hair interference noise.

10. The hearing device of claim 1, wherein the processor is further configured to:
present, based on the determining that the audio signal includes the hair interference noise, a notification to the user.

11. The hearing device of claim 1, wherein the processor is further configured to:
generate a hair interference record based on the hair interference noise; and
transmit, via a communication network, the hair interference record to a computing device separate from the hearing device.

12. The hearing device of claim 11, wherein the hair interference record includes one or more of:
a hair interference timestamp at which the hair interference noise is detected;
one or more classifier modes of the hearing device when the hair interference noise is detected; or
one or more signal attributes of the hair interference noise.

13. The hearing device of claim 1, further comprising:
an accelerometer configured to detect a user movement;
wherein the determining that the audio signal includes the hair interference noise is further based on the user movement detected by the accelerometer.

14. The hearing device of claim 1, wherein the processor is further configured to:
receive, from an additional device, hair data describing user hair of the user;
wherein the determining that the audio signal includes the hair interference noise is further based on the hair data.

15. A method comprising:
capturing, by a microphone of a hearing device, an audio signal;
determining, by the hearing device, that the audio signal includes hair interference noise caused by hair movement associated with a user of the hearing device; and
adjusting, by the hearing device based on the determining that the audio signal includes the hair interference noise, an operation of the hearing device.

16. The method of claim 15, wherein the determining that the audio signal includes the hair interference noise includes:
inputting the audio signal into a machine learning model to generate an output for the audio signal, the output indicating that the audio signal includes the hair interference noise.

17. The method of claim 15, wherein the determining that the audio signal includes the hair interference noise includes:
receiving an additional audio signal captured by an additional microphone associated with the user, the additional microphone being unimpacted by user hair of the user;
computing a similarity score between the audio signal and the additional audio signal;
determining that the similarity score between the audio signal and the additional audio signal satisfies a similarity score threshold; and
determining, based on the determining that the similarity score satisfies the similarity score threshold, that the audio signal includes the hair interference noise.

18. The method of claim 15, wherein the adjusting of the operation of the hearing device includes:
determining a signal attribute of the hair interference noise;
at least partially removing, based on the signal attribute of the hair interference noise, the hair interference noise from the audio signal to generate an output audio signal; and
providing the output audio signal to the user of the hearing device.

19. The method of claim 15, further comprising:
generating a hair interference record based on the hair interference noise; and
transmitting, via a communication network, the hair interference record to a computing device separate from the hearing device.

20. A non-transitory computer-readable medium storing instructions that, when executed, direct a processor of a hearing device to:
capture, using a microphone of the hearing device, an audio signal;
determine that the audio signal includes hair interference noise caused by hair movement associated with a user of the hearing device; and
adjust, based on the determining that the audio signal includes the hair interference noise, an operation of the hearing device.
